(19) United States
(12) Patent Application Publication
(10) Pub. No.: US 2011/0127973 A1
(43) Pub. Date: Jun. 2, 2011

(54) SWITCHED MODE POWER CONVERTER

(75) Inventors: Peter Luerkens, Aachen (DE); Christoph Loef, Aachen (DE); Thomas Scheel, Stolberg (DE); Christian Hattrup, Wurselen (DE); Bernd Ackermann, Aachen (DE)

(73) Assignee: Koninklijke Philips Electronics N.V., Eindhoven (NL)

(21) Appl. No.: 12/994,477

(22) PCT Filed: May 27, 2009
(86) PCT No.: PCT/IB2009/052218

§ 371 Date: Nov. 24, 2010

(30) Foreign Application Priority Data
Jun. 2, 2008 (EP) 08104202.0

(51) Int. Cl. H02M 3/157

(52) U.S. Cl. 323/235

(57) ABSTRACT

The invention provides a switched mode power converter adapted for zero-voltage transition operation, wherein the converter comprises a half-bridge, having a first power switch (206) and a second power switch, a generator (201) adapted for generating a switching signal S1 after a first period of time, wherein the first period of time starts at the switching off of the second power switch, a controller (202) for converting the switching signal S1 into a control signal S2, wherein the first power switch (206) is switched on in case of the control signal S2, wherein the controller (202) comprises a detector (205), wherein the detector (205) is adapted to generate a first signal S3 in case the voltage over the first power switch (206) is decreasing, a processor (203), wherein the processor (203) is adapted to generate a trigger signal S4 in case of a switching signal S1 and while the first signal S3 is not present, a storage element (204), wherein the storage element (204) is adapted to generate the control signal S2 in case of the trigger signal S4 and the switching signal S1, wherein the storage element 204 is adapted to keep the control signal S2 after disappearing of the trigger signal S4, wherein the storage element (204) is adapted to terminate the control signal S2 after disappearing of the switching signal S1.

### FIELD OF THE INVENTION

The present invention relates to a switched mode power converter adapted for zero-voltage transition operation. Further, the invention relates to a method for controlling a switched mode power converter, wherein the converter is adapted for zero-voltage transition operation. Furthermore, the invention relates to a computer tomography system, which comprises such a converter and a programme element, which realizes such a method and a computer readable medium, which comprises such a programme element.

### BACKGROUND OF THE INVENTION

Resonant converters are adapted to supply resonant circuits, a load, and, frequently, a corresponding transformer with electrical energy. Preferred types of resonant converters comprise at least a half bridge. The half bridge comprises two power switches, wherein the power switches are connected in series. Therefore, there is a power switch, which is arranged between the high potential and a changing potential between the high potential and the low potential and another power switch, which is arranged between the changing potential and the low potential. There are different possibilities to control such a resonant converter. A possible mode of operation is soft switching. Soft switching is a mode of operation, which is characterized by the current in a switch being zero at the time the switching occurs (zero-current-switching, ZCS), or that the voltage at the switches is zero at the switching events (zero-voltage-switching, ZVS). In the case, that the voltage at the switches appears shortly after the switching-off, by charging a capacitor in parallel to the switch through the load current, this mode of operation is called zero-voltage-transition switching (ZVT), meaning that the voltage at the switches is zero only during the turn-on and turn-off events of the switches. To enable this, a so-called dead-time between the time periods of conduction of the power switches is required. Therefore, the dead-time is characterized by a period of time during which all power switches are in off-state (not conducting). The appropriate dead-time depends strongly on the operating conditions of the converter. A dead-time, which is too short, can destroy the converter within a few switching cycles. A dead-time, which is too long, leads to extra losses and electromagnetic interferences (EMI), and thus can make a desired operation unfeasible.

Currently, very simple dead-time adaptation methods are used, which require substantial design margins and prevent from optimal use of the converter. Simply, there is used a fixed time period as a dead-time. This fixed dead-time guarantees the protection of the power switches. As a drawback the maximum power of the converter is significantly lower, as the theoretical limitations of the components would allow and the dynamical behaviour has to be regarded as quite bad. There are also self-adaptive methods. The self-adaptive methods of the prior art have the problem of starting during start-up or fall off of regular operation in case of transients which results in non monotonic control behaviour.

### SUMMARY OF THE INVENTION

Accordingly, there might be a need for a device to calculate the optimal time period of the dead-time, wherein the optimal time period is meant as the minimal time period at which a regular operation of the converter is just possible.

These needs may be met by the subject-matter according to one of the independent claims. Advantageous embodiments of the present invention are described in the dependent claims.

According to a first aspect of the invention, it is proposed a switched mode power converter adapted for zero-voltage transition operation, wherein the converter comprises a half-bridge, having a first power switch and a second power switch, a generator adapted for generating a switching signal after a first period of time, wherein the first period of time starts at the switching off of the second power switch, a controller for converting the switching signal into a control signal, wherein the first power switch is switched on in case of the control signal, wherein the controller comprises a detector, wherein the detector is adapted to generate a first signal in case the voltage over the first power switch is decreasing, a processor, wherein the processor is adapted to generate a trigger signal in case of a switching signal and while the first signal is not present, a storage element, wherein the storage element is adapted to generate the control signal in case of the trigger signal and the switching signal, wherein the storage element is adapted to keep the control signal after disappearing of the trigger signal, wherein the storage element is adapted to terminate the control signal after disappearing of the switching signal.

The converter as proposed by the invention can be regarded as robust and providing a self-adaptive dead-time extension. This embodiment avoids the above-mentioned disadvantages and allows stable operation under all circumstances. Further, the converter according to the inventive concept is insensitive to transient operations. As a result thereof the inventive concept renders the possibility to use the converter up to its theoretical limits.

According to a second aspect of the invention, it is proposed a method for controlling a switched mode power converter adapted for zero-voltage transition operation, wherein the converter comprises a half-bridge, having a first power switch and a second power switch, wherein the method comprises the steps of generating a switching signal after a first period of time, wherein the first period of time starts at the switching off of the second power switch, converting the switching signal into a control signal, wherein the first power switch is switched on in case of the control signal, wherein the method comprises the steps of generating a first signal in case the voltage over the first power switch is decreasing, generating a trigger signal in case of a switching signal and while the first signal is not present, generating the control signal in case of the trigger signal and the switching signal, wherein the storage element is adapted to keep the control signal after disappearing of the trigger signal, wherein the storage element is adapted to terminate the control signal after disappearing of the switching signal.

The method according to the invention combines principally the well-known valley-switching with a start-condition. The result thereof is a self-adaptive dead-time extension. Valley switching means, that the upcoming turn-on of a switch is delayed until its blocking voltage has achieved a minimum. The start condition means, that the delay is applied only, if a fall of the blocking voltage has been detected. In this way all extraordinary conditions, which usually result in undue switching delay and which prevent the converter from starting regular operation, are neglected.

According to a third aspect of the invention, it is proposed a computer tomography system comprising a converter according to one of the claims 1 to 8.

According to a fourth aspect of the invention, it is proposed a programme element, which, when being executed by a processor, is adapted to carry out the method of claim 9.

According to a fifth aspect of the invention, it is proposed a computer readable medium having stored the programme element of claim 11.

According to the present invention it is provided a converter, wherein the storage element is a latch.

According to an exemplary embodiment it is provided a converter, wherein the storage element is a bistable multivibrator, especially a flip-flop.

According to the present invention it is provided a converter, wherein

the converter comprises a first delayer for generating a first dead-time such as there is a the period of time between the switching on of the first power switch and the switching off of the second power switch. The first dead-time is adapted to prevent a short circuit of the first power switch and the second power switch.

According to an exemplary embodiment it is provided a converter, wherein

the converter comprises a second delayer for generating a second dead-time such that the voltage over the first power switch falls to zero before the first power switch is turned on. This is a typical behaviour during zero voltage transition operation. The second dead-time is necessary to obtain the zero voltage transition operation.

According to another exemplary embodiment it is provided a converter, wherein the first period of time is longer than the time period from a change of the control signal until the first power switch has changed its conduction state, is shorter than the time period from starting with the disappearance of the switching signal and ending with the first minimum voltage of the first power switch during zero voltage transition operation.

According to another exemplary embodiment it is provided a converter, wherein the first period of time is in the range of 10 to 5000 ns.

According to another exemplary embodiment it is provided a converter, wherein the converter is a part of a DC/AC converter for supplying a resonant circuit and a transformer of a high voltage generator for x-ray applications.

In a situation when one power switch of a half bridge is in the on-state it is not possible to switch on the other power switch of this half bridge. In this case there would be a short circuit and the power switches could be damaged. Therefore, to guarantee a safe mode of operation it is necessary to wait a period of time after the change of one power switch from the on-state (conducting state) to the off-state (non-conducting state) before switching on the other power switch. This procedure assures the prevention of a situation that both power switches are conducting, which would lead to a short circuit.

In addition to this problem it is necessary in order to achieve a zero voltage transition operation a further period of time has to be waited to allow the voltage over a power switch to fall to zero before the power switch is turned on. This additional period of time is usually strongly depending on the operating conditions of the converter. The total period of time, which is required according to the above-mentioned two situations, has to be regarded with respect to the switching of the power switch. Therefore, according to the invention a dead-time is generated, which is extended by a dead-time control module to obtain the total period of time.

It may be seen as a gist of the present invention to optimize the dead-time of a resonant converter, in order to achieve an optimal dynamical behaviour and good utilization of the components.

It should be noted that the following described exemplary embodiments of the invention apply also for the method, the device, the programme element and the computer readable medium.

It should be noted that the above features may also be combined. The combination of the above features may also lead to synergetic effects, even if not explicitly described in detail.

These and other aspects of the present invention will become apparent from and elucidated with reference to the embodiments described hereinafter.

### BRIEF DESCRIPTION OF THE DRAWINGS

Exemplary embodiments of the present invention will be described in the following with reference to the following drawings.

FIG. 1. shows voltage characteristics,

FIG. 2. a block diagram of an embodiment of the invention

FIG. 3 shows a computer tomography gantry.

### DETAILED DESCRIPTION OF EMBODIMENTS

The inventive concept combines the well-known valley-switching with a start-condition. Valley switching means, that the upcoming turn-on of a switch is delayed until its blocking voltage has achieved a minimum. The start condition means, that the delay is applied only, if a fall of the blocking voltage has been detected. In this way all extraordinary conditions, which usually result in undue switching delay and which prevent the converter from starting the regular operation, are neglected.

The essential feature is that only an initial falling transition of the switch voltage is evaluated, and only if this is already ongoing when the switch turn-on-signal occurs. In all other cases, a dead-time extension is not considered and the switch control happens immediately.

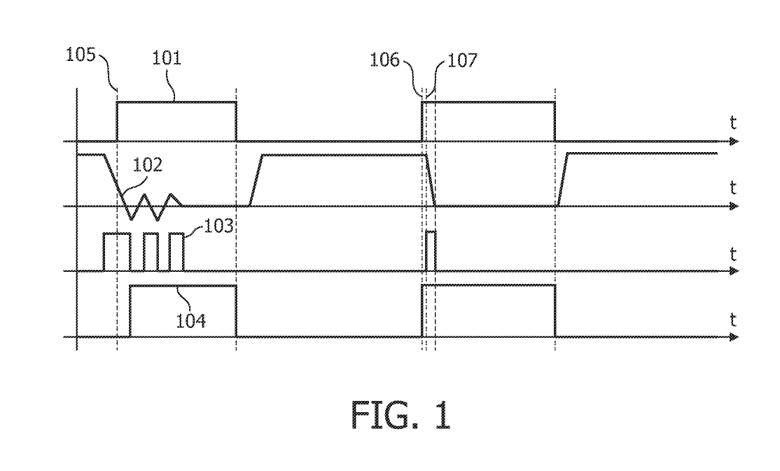

FIG. 1 describes the inventive concept of the present invention. The first diagram depicts a switching signal 101. The switching signal 101 can be interpreted as an enabling signal and indicates the desired state of the power switch. Only in case the switching signal 101 is at hand, it is possible to switch on a power switch. Further, it is not sufficient that the switching signal 101 is present. The edge 105 of the switching signal 101 initiates the possibility to switch on a power switch. The voltage characteristics 102 depicts the voltage over the power switch. At the point of time of the edge 105, the voltage over the power switch is decreasing. This results in a first signal 103. The existence of the first signal 103 prevents the generation of a control signal 104.

During the decreasing of the voltage over the power switch 102, the power switch will be prevented from switching in spite of the existence of the switching signal 101. Finally, the voltage characteristics 102 is constant or increasing, at this situation the power switch can be switched on by a control signal 104.

At the edge 106 of the switching signal 101 there is no decreasing voltage 102. Therefore, the control signal 104 is present at once without delay of time. The later decreasing of the voltage 102 does not result in any changes, because the control signal 104 is already on. Therefore, the changes of the voltage 102 and the first signal 103 will be neglected due to the inventive concept during an on-time period of the power switch, which is controlled by the control signal 104.

The FIG. 1 describes the principle mode of operation of the invention. Shortly before the first occurrence of the switching signal 101, the voltage 102 over the power switch starts to fall. This decreasing of the voltage 102 depends on the inductances and capacitances of the resonant circuit and transformer of a computer tomography system, which is supplied by the power switch. The decreasing is detected by a detector and indicated by the first signal. While this first signal 103 is present, there is no control signal 104. In a next situation the first signal 103 disappears, when the voltage over the power switch 102 stops falling. In this moment the control signal 104 switches the power switch on. Further changes, in particular alternating rising and falling of the voltage over the power switch 102 will have no effect anymore.

A second situation is shown at the edge 106. In this case there is no prevention by a decreasing voltage 102. Therefore, the control signal 104 can switch the power switch on.

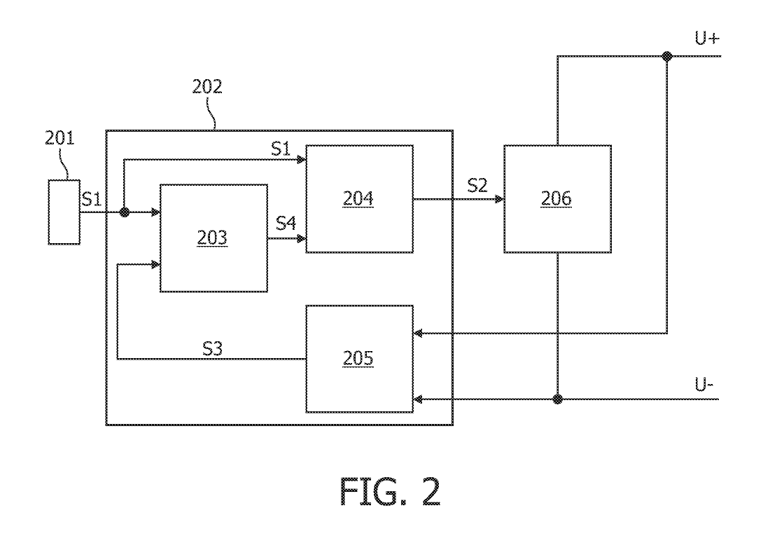

FIG. 2 depicts a block diagram of an embodiment of the invention. The block 206 depicts a power switch. The power switch 206 is adapted to switch a conductive connection between their terminals U+and U−. The power switch 206 is controlled by the control signal S2. The block 202 depicts a controller according to the inventive concept. It is depicted a detector 205, which supervises the voltage between the terminals U+and U−. In case of a decreasing voltage the detector 205 generates a first signal S3. It is depicted a generator 201, which generates a switching signal S1. The switching signal S1 can be regarded as enabling signal for switching on the power switch 206,. The signals S1 (switching signal) and S3 (first signal) will be processed by the processor 203. In case there is a switching signal S1 and no first signal S3 the processor will generate a trigger signal S4. The signals S4 (trigger signal) and S1 (switching signal) will be processed by the storage element 204. In case of a trigger signal S4 and a switching signal S1 the storage element will generate a control signal S2. The power switch 206 will be switched on by a control signal S2. In case the trigger signal S4 changes after the power switch 206 is switched on there is no change. The storage element 204 keeps the control signal S2 as long as there is a switching signal S1. The control signal S2 will be terminated by the storage element 204 only in case the switching signal S1 disappears.

FIG. 2 shows a principle implementation of the invention. With the help of two signal lines the dead-time control system 202 receives the voltage across the controlled power switch 206. This voltage is supplied to the detector 205 in the dead-time control module 202. The detector 205 generates at its output a first signal S3 if the voltage over the power switch 206 is decreasing, i.e. it does not generate a signal if the voltage is constant or rising. In other words, the first signal S3 indicates a falling voltage at the power switch 206. This first signal S3 is sent to a signal blanking block 203, which receives the switching signal S1. If there is a first signal S3 not present, the switching signal S1 will be forwarded to the signal storage block, e.g. a latch, 204. If there is a first signal S3, the blanking block 203 will hold off the propagation of the signal S1 to the storage element 204, as long as the first signal S3 is present. The storage element 204 also receives the switching signal S1. If both signals S1 and S4 are present at the storage element 204, the storage element 204 generates a control signal S2 for the power switch 206. Later changes of the signal S4 are disregarded from now on. Only when signal S1 is removed, i.e. the switching signal S1 is turned off, then the storage element 204 removes also its output signal the control signal S2, and thus turns off the power switch 206.

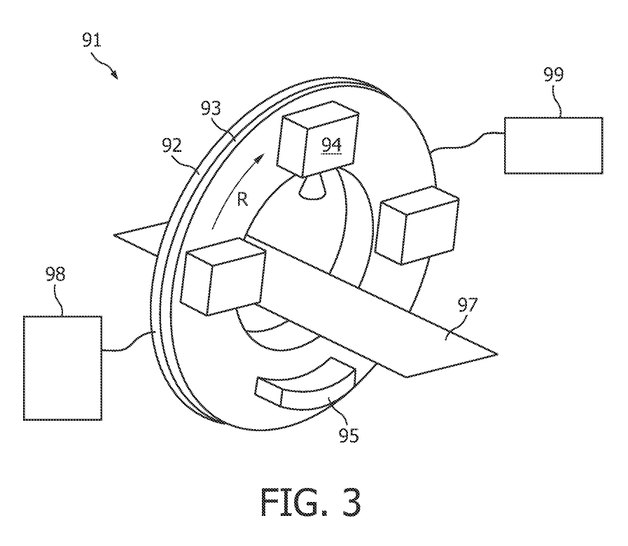

FIG. 3 shows an exemplary embodiment of a computer tomography gantry 91 arrangement. The gantry 91 comprises a stationary part 92 connected to a high frequency power source 98 and a rotary part 93 adapted to rotate relative to the stationary part 92. An X-ray source 94 and an X-ray detector 95 are attached to the rotary part 93 at opposing locations such as to be rotatable around a patient positioned on a table 97. The X-ray detector 95 and the X-ray source 94 are connected to a control and analysing unit 99 adapted to control the X-ray detector 95 and the X-ray source and to evaluate the detection results of the X-ray detector 95.

The self-adaptive controller, which is implemented in the switched mode power converter, avoids the disadvantages of a too long or a too short off time period of the DC/AC-converter and allows stable and robust operation of the DC/AC-converter under all circumstances. The controller is also insensitive to transient operations. Further, it becomes feasible to operate the converter up to the theoretical limits.

The invention can be applied with an X-ray computer tomography system and with a contactless-power-transfer system for computer tomography applications. In these high power applications it allows designing the converter close to the limits of the principle of resonant power converters with ZVT-switching, and thus contributes to the minimization of cost and size of the system.

The invention renders the possibility to design the converter close to the limits of the principle limits of resonant power converters with zero-voltage-transition-switching (ZVT), and thus contributes to the minimization of cost and size of the system. The inventive concept can also be applied in all other kinds of quasi-resonant power converters with zero-voltage-transition switching (ZVT). Especially, smaller power converters can be produced more reliable and with reduced design efforts.

It should be noted that the term ‘comprising’ does not exclude other elements or steps and the ‘a’ or ‘an’ does not exclude a plurality. Also elements described in association with the different embodiments may be combined.

It should be noted that the reference signs in the claims shall not be construed as limiting the scope of the claims.

### LIST OF REFERENCE SIGNS

91 computer tomography gantry,

92 stationary part of the gantry,

93 rotary part of the gantry,

94 x-ray source,

95 x-ray detector,

97 table,

98 high frequency power source,

99 control and analysing unit.

101 switching signal

102 voltage over power switch

103 first signal

104 control signal

201 generator

202 controller

203 processor

204 latch

205 detector

206 power switch

1. A switched mode power converter adapted for zero-voltage transition operation, wherein the converter comprises
a half-bridge, having a first power switch (206) and a second power switch,
a generator (201) adapted for generating a switching signal (S1) after a first period of time, wherein the first period of time starts at the switching off of the second power switch,
a controller (202) for converting the switching signal (S1) into a control signal (S2), wherein the first power switch (206) is switched on in case of the control signal (S2), wherein
the controller (202) comprises
a detector (205), wherein the detector (205) is adapted to generate a first signal (S3) in case the voltage (U+, U−) over the first power switch (206) is decreasing,
a processor (203), wherein the processor (203) is adapted to generate a trigger signal (S4) in case of a switching signal (S1) and while the first signal (S3) is not present,
a storage element (204), wherein the storage element (204) is adapted to generate the control signal (S2) in case of the trigger signal (S4) and the switching signal (S1), wherein the storage element (204) is adapted to keep the control signal (S2) after disappearing of the trigger signal (S4), wherein the storage element (204) is adapted to terminate the control signal (S2) after disappearing of the switching signal (S1).

2. The converter according to claim 1, wherein the storage element (204) is a latch.

3. The converter according to claim 1, wherein the storage element (204) is a bistable multivibrator, especially a flip-flop.

4. The converter according to claim 1, wherein
the converter comprises
a first delayer for generating a first dead-time such as there is a the period of time between the switching on of the first power switch (206) and the switching off of the second power switch.

5. The converter according to claim 1, wherein
the converter comprises
a second delayer for generating a second dead-time such that the voltage (U+, U−) over the first power switch (206) falls to zero before the first power switch (206) is turned on.

6. The converter according to claim 1 wherein the first period of time
is longer than the time period from a change of the control signal (52) until the first power switch (206) has changed its conduction state,
is shorter than the time period starting with the disappearance of the switching signal (S1) and ending with the first minimum voltage of the first power switch (206) during zero voltage transition operation.

7. The converter according to claim 1 wherein the first period of time is in the range of 10 to 5000 ns.

8. The converter according to claim 1, wherein the converter is a part of a DC/AC converter for supplying a resonant circuit and a transformer of a high voltage generator for x-ray applications.

9. A method for controlling a switched mode power converter adapted for zero-voltage transition operation, wherein the converter comprises a half-bridge, having a first power switch (206) and a second power switch, wherein
the method comprises the steps of
generating a switching signal (S1) after a first period of time, wherein the first period of time starts at the switching off of the second power switch,
converting the switching signal (Si) into a control signal (S2), wherein the first power switch (206) is switched on in case of the control signal (S2), wherein
the method comprises the steps of
generating a first signal (53) in case the voltage (U+, U-) over the first power switch (206) is decreasing,
generating a trigger signal (S4) in case of a switching signal (S1) and while the first signal (S3) is not present,
generating the control signal (S2) in case of the trigger signal (S4) and the switching signal (S1), wherein the storage element (204) is adapted to keep the control signal (52) after disappearing of the trigger signal (S4), wherein the storage element (204) is adapted to terminate the control signal (S2) after disappearing of the switching signal (S1).

10. A computer tomography system comprising a converter according to claim 1.

11. A programme element, which, when being executed by a processor, is adapted to carry out the method of claim 9.

12. A computer readable medium having stored the programme element of claim 11.
